(19) United States
(12) Patent Application Publication
(10) Pub. No.: US 2016/0059461 A1
(43) Pub. Date: Mar. 3, 2016

(54) Injection Molding with Localized Heating in Flow Challenge Regions

(71) Applicant: iMFLUX Inc., Cincinnati, OH (US)

(72) Inventors: Gene Michael ALTONEN, West Chester, OH (US); H. Kenneth HANSON, III, Cincinnati, OH (US); Chow-chi HUANG, West Chester, OH (US); Matthew Lloyd NEWMAN, Cincinnati, OH (US); Michael Thomas DODD, Walton, KY (US)

(21) Appl. No.: 14/843,062

(22) Filed: Sep. 2, 2015

Related U.S. Application Data
(60) Provisional application No. 62/045,373, filed on Sep. 3, 2014.

(51) Int. Cl. B29C 45/73; B29C 45/78

(52) U.S. Cl. CPC B29C 45/73; B29C 45/78

(57) ABSTRACT

Injection molding at substantially constant pressure with the use of rapid heating techniques, such as induction heating, at strategic locations within a mold to heat molding surfaces in a manner that mitigates problems typically associated with flow filling challenges.

### TECHNICAL FIELD OF THE INVENTION

This disclosure relates generally to apparatuses and methods for injection molding and, more particularly, to apparatuses and methods for performing injection molding at substantially constant injection pressure while utilizing localized heating methodologies to enhance the quality of injection molded products and product components.

### BACKGROUND OF THE INVENTION

Injection molding is a technology commonly used for high-volume manufacturing of parts made of thermoplastic material. During a repetitive injection molding process, a thermoplastic resin, most often in the form of small beads or pellets, is introduced to an injection molding machine that melts the resin beads under heat and pressure. The now molten resin is forcefully injected into a mold cavity having a particular cavity shape. The injected plastic is held under pressure in the mold cavity, cooled, and then removed as a solidified part having a shape that essentially duplicates the cavity shape of the mold. The mold itself may have a single cavity or multiple cavities.

An injection molding cycle, as used herein, or simply “cycle”, can include the steps of (1) melting a shot of polymeric material; (2) clamping together two (or more) portions of a mold, such as a mold core and a mold cavity plate, that together form the mold walls that define one or more mold cavities (typically while the mold walls are in a cool condition relative to the temperature to which the molten thermoplastic material is heated prior to injection into the mold cavity); (3) forcing the shot of molten polymeric material into the mold cavity; (4) waiting some period of time until the molded polymeric material cools to a temperature sufficient to eject the part, i.e. a temperature below its melt temperature, so that at least outside surfaces of the molded part are sufficiently solid so that the part will maintain its molded shape once ejected; (5) opening the portions of the mold that define the one or more mold cavities; (6) ejecting the molded part(s) from the one or more mold cavities; and (7) closing the two (or more) mold sections (for a subsequent cycle).

The surface characteristics of injection molded parts can be enhanced by heating the surfaces of the mold that define the mold cavity. Examples of heating techniques that may be used to heat surfaces of the mold that define the mold cavity are: Resistive heating (or joule heating), conduction, convection, use of heated fluids (e.g., superheated steam or oil in a manifold or jacket, also heat exchangers), radiative heating (such as through the use of infrared radiation from filaments or other emitters), RF heating (or dielectric heating), electromagnetic inductive heating (also referred to herein as induction heating), use of thermoelectric effect (also called the Peltier-Seebeck effect), vibratory heating, acoustic heating, and use of heat pumps, heat pipes, cartridge heaters, or electrical resistance wires, whether or not their use is considered within the scope of any of the above-listed types of heating.

A known drawback of heating the surfaces of the mold that define the mold cavity as part of an injection molding cycle is that it often increases cycle time. It also increases the energy consumed by the injection molding system. Before the surfaces of the mold that define the mold cavity can be opened and the molded part ejected, the part must be cooled to a temperature below its melt temperature. As such, to the extent those mold surfaces are heated to temperatures at the melt temperature of the thermoplastic material, that heat must be dissipated prior to opening the mold and ejecting the part. Various cooling techniques exist to reduce the temperature of the surfaces of the mold, for example: Heat exchangers, such as finned radiators or heat sinks, where a cooling fluid flowing therein (preferably a liquid medium) is at a lower temperature than the surfaces of the mold requiring cooling, thermoelectric effect heat pumps, laser cooling, leveraging endothermic phase changes, such as evaporative cooling, and use of refrigeration products with a magneto-caloric effect (wherein some materials, such as alloys of gadolinium, in the presence of a diminishing magnetic field, are chilled by the reduction of motion of magnetic dipoles in the material).

Even with these so-called rapid cooling techniques, there is still a significant increase in cycle time, because it takes some time for the surfaces of the mold that define the mold cavity to cool.

### SUMMARY OF THE INVENTION

The present disclosure marries the benefits of rapid heating of surfaces of the mold that define the mold cavity with the advantages of injection molding at substantially constant pressure, and preferably, at substantially constant pressure of 30,000 psi and lower, in some cases, 10,000 psi and lower, and in some cases, 6,000 psi and lower.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 illustrates a schematic view of a low constant pressure injection molding machine constructed according to the disclosure;

FIG. 2 is a cross-sectional view of a region of an injection molding system of the present disclosure including a flow filling challenge in the form of a mold region shaped to form a pair of ribs in a molded part;

FIG. 3 is an isometric sectional view of a region of an injection molding system of the present disclosure including a flow filling challenge in the form of a mold region shaped to form a boss in a molded part;

FIG. 4 is a cross-sectional view of a region of an injection molding system of the present disclosure including a flow filling challenge in the form of a mold region shaped to form a corner in a molded part;

FIG. 5 is an isometric view of a region of an injection molding system of the present disclosure including a flow filling challenge in the form of an obstacle about which molten thermoplastic material must navigate, the obstacle being a core pin;

FIG. 6 is a cross-sectional view of a region of an injection molding system of the present disclosure including a flow filling challenge in the form of a wall thickness transition, i.e. a transition from a nominal wall thickness of a part to be molded to a thicker region of the part to be molded, and back to the nominal wall thickness;

FIG. 7 is a cross-sectional view of a region of an injection molding system of the present disclosure including a flow filling challenge in the form of a wall thickness transition, i.e. a transition from a nominal wall thickness of a part to be molded to a thinner region of the part to be molded, and back to the nominal wall thickness;

FIG. 8 is a plot of induction power vs. time superimposed on the cross-sectional view of the flow filling challenge in the form of a transition, as illustrated in FIG. 6;

FIG. 9 is a cross-sectional view of a region of an injection molding system of the present disclosure including a flow filling challenge in the form of a thin channel within a mold cavity that imparts a living hinge to a part to be molded;

FIG. 10 is a cross-sectional view of a region of an injection molding system of the present disclosure including a flow filling challenge that manifests itself in the form of a weld line at a convergence of two flow fronts from discrete gates of the injection molding system, the discrete gates being at opposite ends of the mold cavity;

FIG. 11 is a sectional view taken in a flow direction of an injection molding system of the present disclosure including flow filling challenges manifested in the form of weld lines at the convergence of two flow fronts from discrete gates of the injection molding system, the discrete gates being positioned in parallel to one another along the mold cavity;

FIG. 12 is an isometric view of a block that may be used to define a portion of a mold cavity, provided with an induction coil frame having a planar induction coil therein to selectively heat the block; and

FIG. 13 is an isometric view of a block that may be used to define a portion of a mold cavity, provided with an induction coil frame having a perimeter induction coil therein to selectively heat at least a periphery of the block.

### DETAILED DESCRIPTION OF THE INVENTION

Embodiments of the present invention generally relate to systems, machines, products, and methods of producing products by injection molding and more specifically to systems, products, and methods of producing products by low substantially constant pressure injection molding.

The term “low pressure” as used herein with respect to melt pressure of a thermoplastic material, means melt pressures in a vicinity of a nozzle of an injection molding machine of 6000 psi and lower.

The term “substantially constant pressure” as used herein with respect to a melt pressure of a thermoplastic material, means that deviations from a baseline melt pressure do not produce meaningful changes in physical properties of the thermoplastic material. For example, “substantially constant pressure’ includes, but is not limited to, pressure variations for which viscosity of the melted thermoplastic material do not meaningfully change. The term “substantially constant” in this respect includes deviations of approximately 30% from a baseline melt pressure. For example, the term “a substantially constant pressure of approximately 4600 psi” includes pressure fluctuations within the range of about 6000 psi (30% above 4600 psi) to about 3200 psi (30% below 4600 psi). A melt pressure is considered substantially constant as long as the melt pressure fluctuates no more than 30% from the recited pressure.

The term “melt holder”, as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit, and can be controlled to advance a diaphragm to force molten plastic through the machine nozzle. The molten material then flows through the runner system in to the mold cavity. The melt holder may be cylindrical in cross section, or have alternative cross sections that will permit a diaphragm to force polymer under pressures that can range from as low as 100 psi to pressures 40,000 psi or higher through the machine nozzle. The diaphragm may optionally be integrally connected to a reciprocating screw with flights designed to plasticize polymer material prior to injection.

The term “peak flow rate” generally refers to the maximum volumetric flow rate, as measured at the machine nozzle.

The term “peak injection rate” generally refers to the maximum linear speed the injection ram travels in the process of forcing polymer in to the feed system. The ram can be a reciprocating screw such as in the case of a single stage injection system, or a hydraulic ram such as in the case of a two stage injection system.

The term “ram rate” generally refers to the linear speed the injection ram travels in the process of forcing polymer into the feed system.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “melt temperature” generally refers to the temperature of the polymer that is maintained in the melt holder, and in the material feed system when a hot runner system is used, which keeps the polymer in a molten state. The melt temperature varies by material, however, a desired melt temperature is generally understood to fall within the ranges recommended by the material manufacturer.

The term “gate size” generally refers to the cross sectional area of a gate, which is formed by the intersection of the runner and the mold cavity. For hot runner systems, the gate can be of an open design where there is no positive shut off of the flow of material at the gate, or a closed design where a valve pin is used to mechanically shut off the flow of material through the gate in to the mold cavity (commonly referred to as a valve gate). The gate size refers to the cross sectional area, for example a 1 mm gate diameter refers to a cross sectional area of the gate that is equivalent to the cross sectional area of a gate having a 1 mm diameter at the point the gate meets the mold cavity. The cross section of the gate may be of any desired shape.

The term “effective gate area” generally refers to a cross sectional area of a gate corresponding to an intersection of the mold cavity and a material flow channel of a feed system (e.g., a runner) feeding thermoplastic to the mold cavity. The gate could be heated or not heated. The gate could be round, or any cross sectional shape, suited to achieve the desired thermoplastic flow into the mold cavity.

The term “intensification ratio” generally refers to the mechanical advantage the injection power source has on the injection ram forcing the molten polymer through the machine nozzle. For hydraulic power sources, it is common that the hydraulic piston will have a 10:1 mechanical advantage over the injection ram. However, the mechanical advantage can range from ratios much lower, such as 2:1, to much higher mechanical advantage ratio such as 50:1.

The term “peak power” generally refers to the maximum power generated when filling a mold cavity. The peak power may occur at any point in the filling cycle. The peak power is determined by the product of the plastic pressure as measured at the machine nozzle multiplied by the flow rate as measured at the machine nozzle. Power is calculated by the formula P=p*Q where p is pressure and Q is volumetric flow rate.

The term “volumetric flow rate” generally refers to the flow rate as measured at the machine nozzle. This flow rate can be calculated based on the ram rate and ram cross sectional area, or measured with a suitable sensor located in the machine nozzle.

The terms “filled” and “full,” when used with respect to a mold cavity including thermoplastic material, are interchangeable and both terms mean that thermoplastic material has stopped flowing into the mold cavity.

The term “shot size” generally refers to the volume of polymer to be injected from the melt holder to completely fill the mold cavity or cavities. The Shot Size volume is determined based on the temperature and pressure of the polymer in the melt holder just prior to injection. In other words, the shot size is a total volume of molten plastic material that is injected in a stroke of an injection molding ram at a given temperature and pressure. Shot size may include injecting molten plastic material into one or more injection cavities through one or more gates. The shot of molten plastic material may also be prepared and injected by one or more melt holders.

The term “hesitation” generally refers to the point at which the velocity of the flow front is minimized sufficiently to allow a portion of the polymer to drop below its no flow temperature and begin to freeze off.

The term “electric motor” or “electric press,” when used herein includes both electric servo motors and electric linear motors.

The term “Peak Power Flow Factor” refers to a normalized measure of peak power required by an injection molding system during a single injection molding cycle and the Peak Power Flow Factor may be used to directly compare power requirements of different injection molding systems. The Peak Power Flow Factor is calculated by first determining the Peak Power, which corresponds to the maximum product of molding pressure multiplied by flow rate during the filling cycle (as defined herein), and then determining the Shot Size for the mold cavities to be filled. The Peak Power Flow Factor is then calculated by dividing the Peak Power by the Shot Size.

The term “low constant pressure injection molding machine” is defined as a class 101 or a class 30 injection molding machine that uses a substantially constant injection pressure that is less than 6000 psi. Alternatively, the term “low constant pressure injection molding machine” may be defined as an injection molding machine that uses a substantially constant injection pressure that is less than 6000 psi and that is capable of performing more than 1 million cycles, preferably more than 1.25 million cycles, more preferably more than 2 million cycles, more preferably more than 5 million cycles, and even more preferably more than 10 million cycles before the mold core (which is made up of first and second mold parts that define a mold cavity therebetween) reaches the end of its useful life. Characteristics of “low constant pressure injection molding machines” include mold cavities having an L/T ratio of greater than 100 (and preferably greater than 200), multiple mold cavities (preferably 4 mold cavities, more preferably 16 mold cavities, more preferably 32 mold cavities, more preferably 64 mold cavities, more preferably 128 mold cavities and more preferably 256 mold cavities, or any number of mold cavities between 4 and 512), a heated runner, and a guided ejection mechanism.

The term “useful life” is defined as the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being force ably closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “guided ejection mechanism” is defined as a dynamic part that actuates to physically eject a molded part from the mold cavity.

The term “coating” is defined as a layer of material less than 0.13 mm (0.005 in) in thickness, that is disposed on a surface of a mold part defining the mold cavity, that has a primary function other than defining a shape of the mold cavity (e.g., a function of protecting the material defining the mold cavity, or a function of reducing friction between a molded part and a mold cavity wall to enhance removal of the molded part from the mold cavity).

The term “average thermal conductivity” is defined as the thermal conductivity of any materials that make up the mold cavity or the mold side or mold part. Materials that make up coatings, stack plates, support plates, and gates or runners, whether integral with the mold cavity or separate from the mold cavity, are not included in the average thermal conductivity. Average thermal conductivity is calculated on a volume weighted basis.

The term “effective cooling surface” is defined as a surface through which heat is removed from a mold part. One example of an effective cooling surface is a surface that defines a channel for cooling fluid from an active cooling system. Another example of an effective cooling surface is an outer surface of a mold part through which heat dissipates to the atmosphere. A mold part may have more than one effective cooling surface and thus may have a unique average thermal conductivity between the mold cavity surface and each effective cooling surface.

The term “nominal wall thickness” is defined as the theoretical thickness of a mold cavity if the mold cavity were made to have a uniform thickness. The nominal wall thickness may be approximated by the average wall thickness. The nominal wall thickness may be calculated by integrating length and width of the mold cavity that is filled by an individual gate.

The term “average hardness” is defined as the Rockwell hardness for any material or combination of materials in a desired volume. When more than one material is present, the average hardness is based on a volume weighted percentage of each material. Average hardness calculations include hardnesses for materials that make up any portion of the mold cavity. Average hardness calculations do not include materials that make up coatings, stack plates, gates or runners, whether integral with a mold cavity or not, and support plates. Generally, average hardness refers to the volume weighted hardness of material in the mold cooling region.

The term “mold cooling region” is defined as a volume of material that lies between the mold cavity surface and an effective cooling surface.

The term “cycle time” is defined as a single iteration of an injection molding process that is required to fully form an injection molded part. Cycle time includes the collective time it takes to perform the steps of advancing molten thermoplastic material into a mold cavity, substantially filling the mold cavity with thermoplastic material, cooling the thermoplastic material, separating first and second mold sides to expose the cooled thermoplastic material, removing the thermoplastic material, and closing the first and second mold sides.

The term “skin” or “skin layer” is defined as a surface layer of a molded part. While it is recognized that skin or skin layer can be considered in the context of a molded part's surface aesthetics, which may include the texture or finish of the part, and thus have a depth on the order of only 5% of the wall thickness, when considering the skin layer as it relates to most mechanical properties of a molded part, the skin layer may include the outer 20% of the part.

The term “flow filling challenge” is defined as a region of a part of a mold that forms a feature of a part to be molded which is particularly susceptible to any one or more of a number of problems that complicate the molding of the part or render the molded part more likely to suffer from one or more defects or reduced mechanical properties, such as short-fills, warp, sinks, brittleness, flash, voids, non-fills, weakness (e.g., low tensile, torsional, and/or hoop strength), high stress concentrations, low modulus, reduced resistance to chemical exposure, premature fatigue, non-uniform shrinkage, and discontinuities in color, surface texture, opacity, translucency, or transparency. Non-exhaustive examples of flow filling challenges are: Locations in a mold used to form ribs, bosses, or corners, as well as obstacles in a mold (such as core pins), and transitions (such as a change in thickness of a part to be molded, which may be a sudden stepped change in thickness or a gradual change in thickness, such as a tapered region). These can involve a transition from a relatively thick region to a relatively thin region, and then back to a relatively thick region, and may involve one or more changes in thickness. A transition of particular interest for purposes of the present disclosure is a living hinge, which is typically an integral, relatively thin region of a molded part that permits one portion of the part, such as a flip-top of a cap, to rotate with respect to the rest of the part. As the term flow filling challenge is used herein, it is contemplated that the region of the part affected by a particular challenge may be at a particular position, along a region, or downstream of a particular position or region, and as such, a flow filling challenge need not be limited to a particular location of a change in shape of a mold, but may extend beyond, i.e. downstream of, such a location.

The term “flow front” refers to a leading edge of a shot of molten polymeric material, as experienced by the surfaces of the mold that define a mold cavity, as the molten polymeric material is progressing from a nozzle or gate of the mold cavity (i.e., a point or points of introduction of the molten polymeric material to the mold cavity) toward, and ultimately to, an end-of-fill location of the mold cavity.

The term “rapid heating technique” refers to any manner of increasing the surface temperature of one or more regions of a mold that define any part of a mold cavity, in a short period of time, including resistive heating (or joule heating), conduction, convection, use of heated fluids (e.g., superheated steam or oil in a manifold or jacket, also heat exchangers), radiative heating (such as through the use of infrared radiation from filaments or other emitters), RF heating (or dielectric heating), electromagnetic inductive heating (also referred to herein as induction heating), use of thermoelectric effect (also called the Peltier-Seebeck effect), and use of heat pumps, heat pipes, cartridge heaters, or electrical resistance wires, whether or not their use is considered within the scope of any of the above-listed types of heating.

The term “upstream” refers to a relative location in a mold cavity that a flow front progressing through the mold cavity reaches prior to a given reference location, such that if a flow front of thermoplastic material in a mold cavity reaches location X prior to location Y of the mold cavity as the flow front progresses through the mold cavity, it is said that location X is upstream of location Y.

The term “downstream” refers to a relative location in a mold cavity that a flow front progressing through the mold cavity reaches after passing a given reference location, such that if a flow front of thermoplastic material in a mold cavity reaches location Z after location Y of the mold cavity as the flow front progresses through the mold cavity, it is said that location Z is downstream of location Y.

The term “surface area of the mold” refers to the collective area of the surfaces of the mold that together form the mold walls defining one or more mold cavities, to the extent thermoplastic material injected into the mold cavity is exposed to those surfaces in order to form a full molded part.

Low constant pressure injection molding machines may also be high productivity injection molding machines (e.g., a class 101 or a class 30 injection molding machine, or an “ultra high productivity molding machine”), such as the high productivity injection molding machine disclosed in U.S. patent application Ser. No. 13/601,514, filed Aug. 31, 2012, which is hereby incorporated by reference herein, that may be used to produce thinwalled consumer products, such as toothbrush handles and razor handles. Thin walled parts are generally defined as having a high L/T ratio of 100 or more.

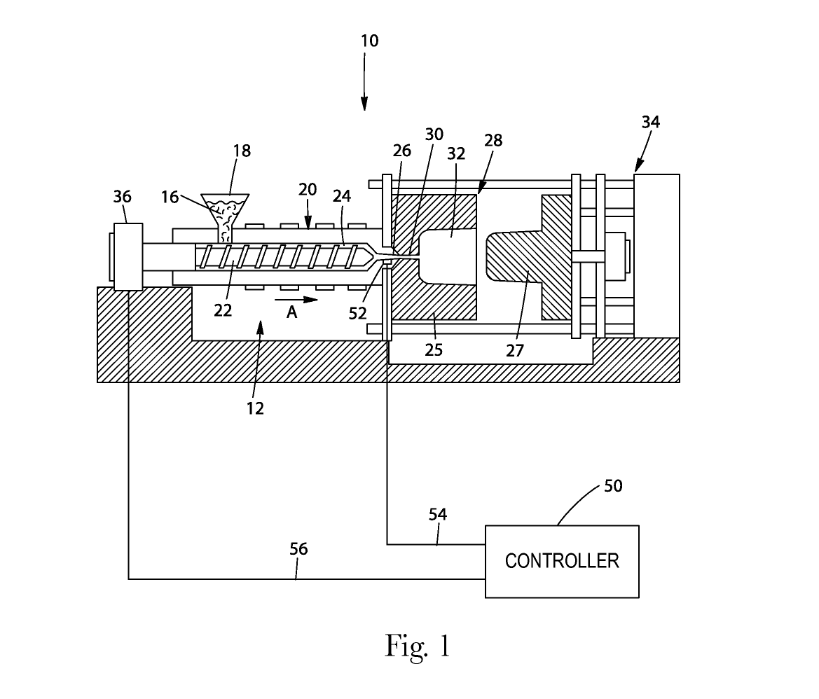

Referring to the figures in detail, FIG. 1 illustrates an exemplary low constant pressure injection molding apparatus 10 that generally includes an injection system 12 and a clamping system 14. A thermoplastic material may be introduced to the injection system 12 in the form of thermoplastic pellets 16. The thermoplastic pellets 16 may be placed into a hopper 18, which feeds the thermoplastic pellets 16 into a heated barrel 20 of the injection system 12. The thermoplastic pellets 16, after being fed into the heated barrel 20, may be driven to the end of the heated barrel 20 by a reciprocating screw 22. The heating of the heated barrel 20 and the compression of the thermoplastic pellets 16 by the reciprocating screw 22 causes the thermoplastic pellets 16 to melt, forming a molten thermoplastic material 24. The molten thermoplastic material is typically processed at a temperature of about 130° C. to about 410° C.

The reciprocating screw 22 forces the molten thermoplastic material 24, toward a nozzle 26 to form a shot of thermoplastic material, which will be injected into a mold cavity 32 of a mold 28 via one or more gates 30, preferably three or less gates, that direct the flow of the molten thermoplastic material 24 to the mold cavity 32. In other embodiments the nozzle 26 may be separated from one or more gates 30 by a feed system (not shown). The mold cavity 32 is formed between first and second mold sides 25, 27 of the mold 28 and the first and second mold sides 25, 27 are held together under pressure by a press or clamping unit 34. The press or clamping unit 34 applies a clamping force during the molding process that is greater than the force exerted by the injection pressure acting to separate the two mold halves 25, 27, thereby holding the first and second mold sides 25, 27 together while the molten thermoplastic material 24 is injected into the mold cavity 32. To support these clamping forces, the clamping system 14 may include a mold frame and a mold base.

Once the shot of molten thermoplastic material 24 is injected into the mold cavity 32, the reciprocating screw 22 stops traveling forward. The molten thermoplastic material 24 takes the form of the mold cavity 32 and the molten thermoplastic material 24 cools inside the mold 28 until the thermoplastic material 24 solidifies. Once the thermoplastic material 24 has solidified, the press 34 releases the first and second mold sides 25, 27, the first and second mold sides 25, 27 are separated from one another, and the finished part may be ejected from the mold 28. The mold 28 may include a plurality of mold cavities 32 to increase overall production rates. The shapes of the cavities of the plurality of mold cavities may be identical, similar or different from each other. (The latter may be considered a family of mold cavities).

A controller 50 is communicatively connected with a sensor 52, located in the vicinity of the nozzle 26, and a screw control 36. The controller 50 may include a microprocessor, a memory, and one or more communication links. The controller 50 may also be optionally connected to a sensor 53 located proximate an end of the mold cavity 32. This sensor 52 may provide an indication of when the thermoplastic material is approaching the end of fill in the mold cavity 32. The sensor 52 may sense the presence of thermoplastic material optically, pneumatically, mechanically, electro-mechanically, or by otherwise sensing pressure and/or temperature of the thermoplastic material. When pressure or temperature of the thermoplastic material is measured by the sensor 52, this sensor 52 may send a signal indicative of the pressure or the temperature to the controller 50 to provide a target pressure for the controller 50 to maintain in the mold cavity 32 (or in the nozzle 26) as the fill is completed. This signal may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52, and/or the sensor 53, and the screw control 36 via wired connections 54, 56, respectively. In other embodiments, the controller 50 may be connected to the sensors 52, 53 and screw control 56 via a wireless connection, a mechanical connection, a hydraulic connection, a pneumatic connection, or any other type of communication connection known to those having ordinary skill in the art that will allow the controller 50 to communicate with both the sensors 52, 53 and the screw control 36.

In the embodiment of FIG. 1, the sensor 52 is a pressure sensor that measures (directly or indirectly) melt pressure of the molten thermoplastic material 24 in vicinity of the nozzle 26. The sensor 52 generates an electrical signal that is transmitted to the controller 50. The controller 50 then commands the screw control 36 to advance the screw 22 at a rate that maintains a desired melt pressure of the molten thermoplastic material 24 in the nozzle 26. While the sensor 52 may directly measure the melt pressure, the sensor 52 may also indirectly measure the melt pressure by measuring other characteristics of the molten thermoplastic material 24, such as temperature, viscosity, flow rate, etc, which are indicative of melt pressure. Likewise, the sensor 52 need not be located directly in the nozzle 26, but rather the sensor 52 may be located at any location within the injection system 12 or mold 28 that is fluidly connected with the nozzle 26. If the sensor 52 is not located within the nozzle 26, appropriate correction factors may be applied to the measured characteristic to calculate an estimate of the melt pressure in the nozzle 26. The sensor 52 need not be in direct contact with the injected fluid and may alternatively be in dynamic communication with the fluid and able to sense the pressure of the fluid and/or other fluid characteristics. If the sensor 52 is not located within the nozzle 26, appropriate correction factors may be applied to the measured characteristic to calculate the melt pressure in the nozzle 26. In yet other embodiments, the sensor 52 need not be disposed at a location that is fluidly connected with the nozzle. Rather, the sensor could measure clamping force generated by the clamping system 14 at a mold parting line between the first and second mold parts 25, 27. In one aspect the controller 50 may maintain the pressure according to the input from sensor 52. Alternatively, the sensor could measure an electrical power demand by an electric press, which may be used to calculate an estimate of the pressure in the nozzle.

Although an active, closed loop controller 50 is illustrated in FIG. 1, other pressure regulating devices may be used instead of the closed loop controller 50. For example, a pressure regulating valve (not shown) or a pressure relief valve (not shown) may replace the controller 50 to regulate the melt pressure of the molten thermoplastic material 24. More specifically, the pressure regulating valve and pressure relief valve can prevent overpressurization of the mold 28. Another alternative mechanism for preventing overpressurization of the mold 28 is an alarm that is activated when an overpressurization condition is detected.

In a substantially constant injection molding system, the location of the flow front of the molten polymeric material can be detected at desired locations with the mold cavity 32. As described above, the fact that the flow front has reached a particular location in the mold cavity 32 may be detected by a sensor 52 or 53. For instance, the sensor 52 may take the form of a pressure transducer, and may use vacuum pressure. One or more temperature sensors, such as thermal resistors, could be used instead of or in addition to a pressure sensor to determine or verify that the flow front has reached a given location of a mold cavity 32. Such a sensor 52 or 53 may operate by either sensing temperature or pressure, or by sensing a lack thereof. For instance, the sensor could sense a flow of air, and upon interruption, the sensor 52 or 53 may detect that interruption and communicate to the controller 50 that the air flow has been interrupted.

A particular advantage of detecting the presence of the flow front at a certain location with the mold cavity 32 is that data as to the flow front's proximity to a given location in the mold, such as a flow filling challenge, can be used to help mitigate problems conventionally associated with the flow filling challenge. For instance, a rapid heating technique such as induction heating can be applied to a flow filling challenge upon the flow front reaching a location prior to (i.e., upstream of) the flow filling challenge. The induction heating or other rapid heating technique could be continually applied to the flow filling challenge until the flow front reaches the end-of-fill, or until the flow front reaches some predetermined location short of the end-of-fill, such as a location indicative of the flow front having reached a position representing coverage of 50%, 55%, 60%, 65%, 70%, 75%, 80%, 85%, 90%, 91%, 92%, 93%, 94%, 95%, 96%, 97%, 98%, or 99% of the surface area of the mold by thermoplastic material, or any integer or fraction of an integer between those percentages or between 99% and 100%. Alternatively, the induction heating or other rapid heating technique could be continually applied to the flow filling challenge until the flow front reaches a predetermined distance after (i.e., downstream of) the flow filling challenge, such as 1 mm, 2 mm, 3 mm, 4 mm, 5 mm, 6 mm, 7 mm, 8 mm, 9 mm, 1 cm, 2 cm, 5 cm, 10 cm, or any fraction of a centimeter or millimeter beyond the flow filling challenge until the end-of-fill. It is further recognized that it may be desired to discontinue applying the induction heating or other rapid heating technique upon the flow front reaching a position prior to the end of the flow filling challenge. Alternately, it may be desired to continue applying the induction heating or other rapid heating technique for some predetermined duration of time even after end-of-fill. In particular, by continuing to heat only one or more discrete regions of the mold after end-of-fill, that or those particular regions of the mold continue to warm thermoplastic material in contact or close proximity therewith, while other regions of the molded part are cooling. Furthermore, it may be desired to intermittently apply induction heating or other rapid heating technique to one or more particular regions of a mold.

Not only does an injection molding system of the present disclosure have the capability to apply, and discontinue applying, a rapid heating technique such as induction heat to a localized region of a mold based on the location of the flow front, but the system could also be implemented in a manner that, subsequent to initiation of the rapid heating technique, reduces or increases the intensity of the rapid heating technique based on the location of the flow front instead of stopping the heating. For instance, upon the flow front reaching a position upstream of a flow filling challenge in the form of a transition, it may be desirable to apply a rapid heating technique, such as induction heating, at a first intensity to bring the flow filling challenge region to a first temperature. Then, upon the flow front reaching a position within the flow filling challenge region, changing the intensity of the rapid heating technique to a second intensity. The second intensity may be lower than the first intensity, but still sufficient to heat the thermoplastic material passing the flow filling challenge to a desired temperature, such as a temperature at or above a melt temperature of the thermoplastic material.

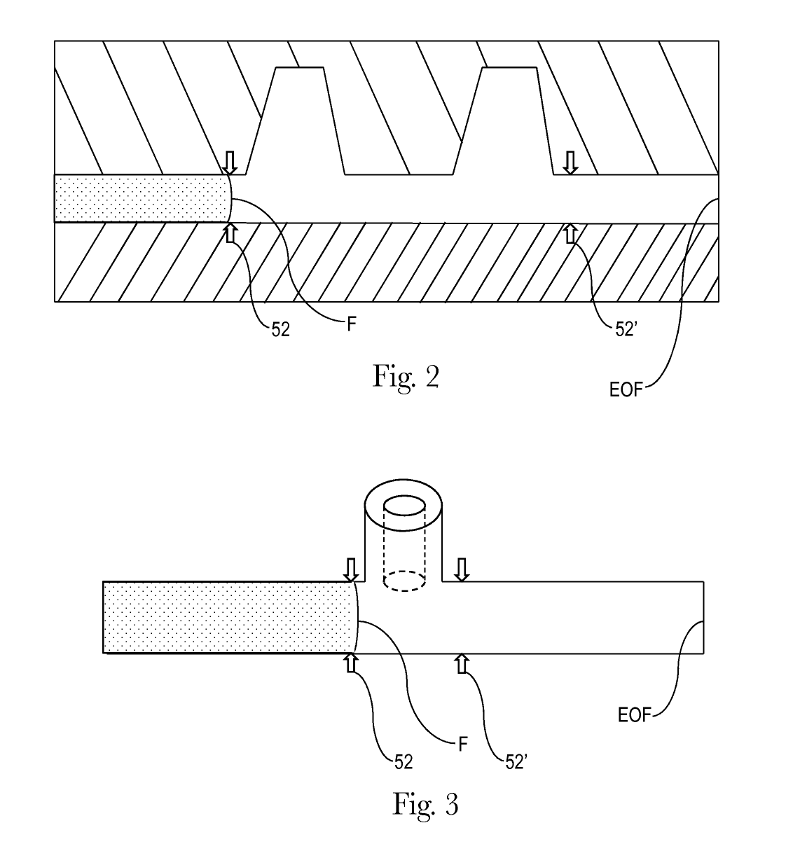

As illustrated in FIG. 2, when encountering a flow filling challenge in the form of mold regions sized and shaped to form one or more ribs in a molded part (hereinafter referred to as “ribs”), a first flow front position sensor 52 may be disposed at a first position upstream of the flow filling challenge and a second flow front position sensor 52′ may be positioned downstream of the flow filling challenge. Once the sensor 52 detects the presence of the flow front F at the first position, the sensor 52 sends a signal to a controller (which may be the same controller as the closed loop controller 50 depicted in FIG. 1, or may alternately be a separate controller dedicated to control of an induction heater or other rapid heating technique) indicative of the flow front F having reached the first position. The controller in turn activates an induction heater (or other rapid heating technique) to heat the flow filling challenge region of the mold.

There are at least two reasons ribs are considered a flow filling challenge. First, depending on such variables as the height of the rib to be formed, and the temperature, viscosity, flow rate, mass flow index, and/or pressure, of the thermoplastic material used for molding, there may be regions of the ribs that are inadequately filled (referred to in the art as non-fill). Second, depending on such factors as the width of a rib and the sharpness of the angle the rib makes with the (nominal) wall thickness preceding and trailing the rib of the part to be molded, as well as the material properties of the thermoplastic material, there is a tendency toward high stress concentrations at the intersections of the molded rib and the rest of the molded part. Induction heat may be used to mitigate either or both of these problems. For instance, if a rib is relatively short in height and non-fill is not an issue, it may not be necessary to construct induction heating elements (or structure to carry out one or more other rapid heating techniques) along the full depth of the rib. However, high stress concentrations can be ameliorated by constructing induction heating elements (or structure to carry out one or more other rapid heating techniques) at the base of the rib (i.e., to apply concentrated heat to portions of the mold used to form the intersections of the rib and the rest of the molded part).

Not only does the use of induction heat or other localized rapid heating techniques in the flow filling challenge region reduce problems typically associated with ribs, but such localized heating, when coupled with a substantially constant pressure injection molding process, also avoids the need to resort to measures conventionally employed to counteract those problems. For instance, many injection molders heat thermoplastic materials to higher temperatures than manufacturer's recommended maximum temperature or to the high end of the recommended processes spectrum, such as in the upper 80% of the recommended temperature range, prior to introducing the shot of molten thermoplastic material into the mold cavity. This is done in order to help assure flow into deeper (taller) ribs, mold parts at higher pressures, and/or spend more time packing their mold cavities after reaching end-of-fill. These techniques require significantly more energy, and increase cycle time. These conventional techniques may also require the use of more costly thermoplastic materials that can withstand those higher temperatures. By utilizing a combination of substantially constant pressure and localized induction heating along at least a portion of the flow filling challenge, molders can avoid having to resort to such measures as over-heating the thermoplastic material prior to molding, molding at excessive pressures, or packing for extended periods of time after reaching end-of-fill. In fact, because a substantially constant pressure process essentially packs the mold cavity as it fills the mold cavity, packing after reaching end-of-fill is obviated, and the localized induction heating in the ribs (or, as seen below, in other flow filling challenge regions as well) adequately addresses the problems typically associated with the flow filling challenge. There may still be some increase in cycle time when employing localized induction heating (or other rapid heating techniques) with a substantially constant pressure injection molding process according to the present disclosure (as compared to injection molding with no increased temperature of the thermoplastic material, no increased pressure, and no extra packing after end-of-fill). However, the increased cycle time by this technique is about 25% less than the increase in cycle time that results from the methodologies conventionally employed to overcome problems associated with flow filling challenges or to achieve the desired surface finish benefits typically associated with augmenting pre-shot heating of the thermoplastic material by heating of the mold surfaces. By limiting the use of induction heating (or other rapid heating techniques) to regions of a mold that are used to form regions of a molded part thinner than a nominal wall thickness of the part, it may be that heat can dissipate from those thinned regions sufficiently fast so that cycle time does not even increase. This is particularly facilitated by use of mold surfaces having higher thermal conductivity than tool steel and other materials conventionally employed for high cycle capacity, multi-cavity production molds. For instance, when molding at substantially constant, low pressure, at or below 6000 psi, a mold may be made from aluminum, Alcoa QC-10, Alcan Duramold 500, or Hokotol (available from Aleris) instead of tool steel. Such materials have a relatively high thermal conductivity, greater than 30 BTU/HR FT ° F., so heat will dissipate from the mold surface faster than conventional molds that employed inductive heating or other rapid heating techniques at or near the mold surface. This can reduce the need for rapid cooling techniques or help maintain a controlled thermal differential. Because heat will dissipate faster through relatively thin wall portions and through Aluminum or other mold materials having higher thermal conductivity than conventional tool steel, increases in cycle time due to heating of the mold surface could be minimized or avoided altogether.

In addition, by combining injection molding at substantially constant pressure with induction heating at one or more molding surfaces, the temperature of a given thermoplastic material can be substantially less than the core temperature to which that thermoplastic material is understood to be required using conventional injection molding. For instance, while materials manufacturers recommend injection pressures in a given range, and further recommend melting temperatures in a certain range, the lower threshold of those ranges is typically set based on one or more factors such as the viscosity of the polymer at a certain temperature or pressure, rheology of the polymer, shear rate, some minimum offset above nominal melt temperature, and fill content. Through injection molding at substantially constant pressure, the polymer is essentially continuously packed as the mold cavity is being filled. By combining the advantages of substantially constant pressure injection molding with the ability to apply localized heat to mold surfaces, particularly at flow filling challenges, high quality parts may be formed with polymers molded at temperatures below the minimum molding temperature in the manufacturer's recommended molding temperature range. The ratio of heat contained in 1 g of a given polymer at minimum melting temperature in a manufacturer's recommended molding temperature range to the heat contained in 1 g of that same polymer at a melting temperature of the polymer when injection molded at substantially constant pressure in an injection molding system of the present disclosure is less than 1. For some materials, the ratio is less than 0.95. For some materials, the ratio is less than 0.9. For some materials, the ratio is less than 0.85. For some materials, the ratio is less than 0.8.

Turning back to FIG. 2, once the flow front F reaches the second sensor 52′ downstream of the flow filling challenge, the sensor 52′ sends a signal to the controller (which may be the same controller as the closed loop controller 50 depicted in FIG. 1, or may alternately be the separate controller dedicated to control of an induction heater or other rapid heating technique), indicative of the flow front F having reached the second position. The controller in turn makes a change to the induction heater (or other rapid heating technique). This change may involve deactivating the induction heater (or other rapid heating technique), thereby discontinuing the application of concentrated heat to the flow filling challenge region of the mold, or changing the intensity of the induction heater (or other rapid heating technique).

While the sensed location of the flow front F is useful, other data from sensors provided in or in close proximity to one or more of the cavities of a mold are useful. For instance, in order to maintain substantially constant pressure while injection molding, or preferably, substantially constant low pressure, it is desirable to provide the controller 50 with real-time data as to pressure of the thermoplastic material, rate of progression of the flow front F, and/or temperature of the thermoplastic material. Some sensors used to detect and relay data concerning these and other operating conditions useful in maintaining constant pressure are susceptible to electromagnetic interference from the induction heater or other rapid heating technique. Electromagnetic interference can result in inaccurate data, which can lead to the controller 50 commanding unnecessary (and potentially undesirable) automatic adjustments to the screw control 36. To avoid this, the system can be implemented such that data from sensors that detect and relay data concerning operating conditions used in maintaining constant pressure which are susceptible to, but lack adequate shielding from, such electromagnetic interference is disregarded during operation of the induction heater or other rapid heating technique. To accomplish this, upon detection by the sensor 52 of the flow front F reaching the first position, not only does the controller 50 command the induction heater to activate, but also signals a processor associated with the controller to ignore data from one or more other sensors that detect operating conditions used in maintaining constant pressure. Once the sensor 52′ detects the flow front F reaching the second position, the controller 50 commands the induction heater to deactivate, and signals the processor to again consider data from one or more other sensors that were disregarded during operation of the induction heater. To the extent the intensity of the induction heater may be reduced to a level that mitigates electromagnetic interference while still providing some elevated temperature to one or more regions of the mold surface, it may be sufficient to reduce the intensity of the induction heater rather than deactivate the induction heater altogether.

Alternately, based, for example on the distance from the nozzle to the first position and the time it takes from initiation of the shot for the flow front F to reach the first position (as detected by the sensor 52), a flow velocity or flow rate can be determined. Based on that flow rate, the processor can be programmed to extrapolate the progress of the flow front F and ignore the data from one or more sensors that detect operating conditions used in maintaining constant pressure for a calculated length of time, which period of time corresponds to the estimated time it would take the flow front F, moving at the calculated flow rate, to reach a given position at, or downstream of, a mold location where the inductive heater is turned off. Optionally, the induction heater may be controlled so as to deactivate based on a similar time calculation based on a distance extrapolation using the flow rate at the first position. Instead of the time to travel from the nozzle to the first position, for a more accurate instantaneous flow rate determination, the flow rate used to determine when to stop ignoring data from other sensors, when to turn off the inductive heater, or both, may be measured based on the time for the flow front F to travel to the location of the sensor 52 from an additional flow front F position sensor further upstream of the flow filling challenge.

The manner in which the controller 50 signals the processor to, during operation of the induction heater (or other rapid heating technique), ignore or disregard data from one or more sensors that detect and relay data concerning operating conditions used in maintaining constant pressure, then signals the processor to again consider data from such sensor(s) upon (or sometime after) deactivation of the induction heater (or other rapid heating technique) could be repeated. In other words, the controller can alternate between providing localized induction heat to particular regions of the mold, such as at or in the vicinity of a flow filling challenge, while not making adjustments based on readings from one or more sensors regarding operating conditions used in maintaining constant pressure, and making adjustments (if necessary in order to maintain substantially constant pressure) based on readings from one or more sensors regarding operating conditions while not applying induction heat. In this manner, benefits of both localized induction heating and injection molding at substantially constant pressure can be realized, while avoiding detrimental effects of electromagnetic interference during operation of one or more induction heating elements.

### Bosses

Turning to FIG. 3, a second flow filling challenge is illustrated, namely that of a boss. Bosses are typically employed to create a reinforced aperture to receive a fastener, such as a screw. Problems associated with bosses are similar to those associated with ribs, namely non-fill and stress concentration at corners. Because bosses are typically formed, at least in part, by a pin that forms the interior of the walled aperture of the boss, and the region of the mold that forms the exterior of the boss wall. Induction heating or other rapid heating technique can be used on the region of the mold that forms the exterior of the boss wall. Additionally or alternately, the pin may be provided with localized heat by a rapid heating technique.

It may be desirable to apply a rapid cooling technique to the pin or the region of the mold that forms the exterior of the boss wall, or both. By cooling one or the other of the pin or the region of the mold that forms the exterior of the boss wall while heating the other, a thermal differential can be controlled and maintained, which may be advantageous to optimize crystallinity in the boss of the molded part, providing the boss with a higher modulus and strengthening the boss.

As with the flow filling challenge of ribs, a sensor 52 can be disposed in a first position prior to (i.e., upstream of) the boss. The presence and location of a second sensor 52′ may depend on the location of the boss and the duration of time after the flow front F passes the boss that it is desired to continue to apply inductive heating or another rapid heating technique to at least a portion of the region of the mold and/or pin that form the boss in a molded part. For instance, because a flow front F may fill and travel beyond a boss so quickly, it may be inadequate to only activate an induction heater associated with the boss location for the short duration it takes for the flow front F to cross that boss location. If a boss location is in the proximity of the end-of-fill, it may even be desired to continue application of the induction heat until end-of-fill or even longer. In such circumstances, a second sensor 52′ is unnecessary, provided some other technique for determining when end-of-fill is reached, such as a pressure sensor associated with a nozzle of the injection molding system. Also, a flow rate-based determination of when to cut off the induction heat or other rapid heating technique may render a second sensor 52′ unnecessary. However, if desired, a second sensor 52′ can be provided at a second location downstream of the boss location. Upon detection of the flow front F reaching that second location (as confirmed by the second sensor 52′), the induction heater or other rapid heating technique may be deactivated.

### Corners

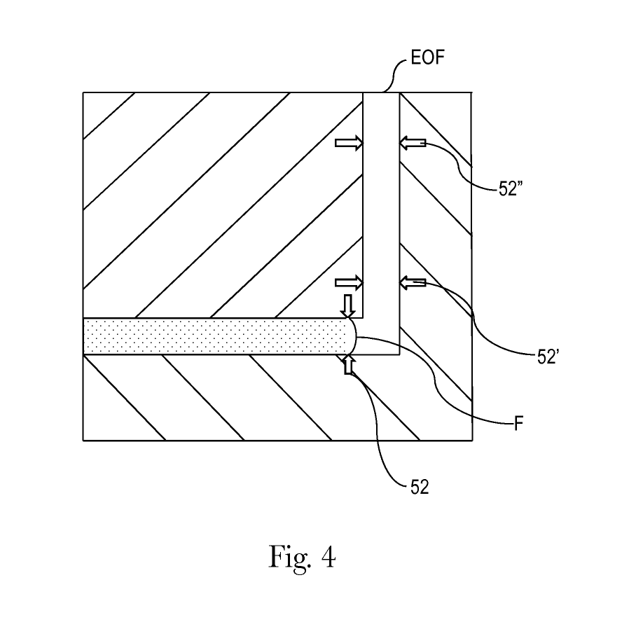

Turning to FIG. 4, a flow filling challenge in the form of a corner is illustrated. Corners can be a point of weakness in a molded part due to, for instance, the high stress concentration and high shear forces. It is also extremely difficult to pack-fill the extreme corner, particularly if it is a sharp corner. By applying heat to the vicinity of the flow filling challenge, the thermoplastic material in the corner region may be maintained at its melting temperature for a longer duration and will start to cool after the flow front F passes that region. As it would not necessarily be required to apply heat to the vicinity of the corner during the entire duration of molding, as with the cases of ribs and bosses, a sensor 52 positioned upstream of the corner may detect the presence of the flow front F as it approaches the corner. This results in a signal being sent to a controller (which may be the same controller as the closed loop controller 50 depicted in FIG. 1, or may alternately be a separate controller dedicated to control of an induction heater or other rapid heating technique) indicative of the flow front F having reached the first position. The controller in turn activates an induction heater (or other rapid heating technique) to heat the corner region of the mold. A second sensor 52′ may be positioned downstream of the corner. Upon the second sensor 52′, a signal may be sent to the controller indicative of the flow front F reaching the position of the second sensor 52′, i.e. a second position downstream of the corner. The controller may then deactivate the induction heater, or may reduce the intensity of the induction heater.

While the second sensor 52′ may be positioned downstream, but still relatively close to, the corner flow filling challenge, the second sensor may instead be at a location indicated by sensor 52″ in FIG. 4, closer to the end-of-fill (EOF) position. Alternatively, the sensor 52″ may be a third sensor, such that upon detection of the flow front F reaching the first position (i.e., the location of the first sensor 52), the induction heater is activated to a first intensity. Upon detection of the flow front F reaching a second position (i.e., the location of the second sensor 52′) the intensity of the induction heater may be reduced to a second intensity lower than the first intensity. Then, upon detection of the flow front F reaching a third position (i.e., the location of the third sensor 52″), the induction heater may be deactivated. As a further alternate, the induction heater may be permitted to remain active until the flow front F reaches the end-of-fill EOF position, or even permitted to remain active for some predetermined period of time after the flow front F reaches the end-of-fill EOF position, either at its full intensity, or at some reduced intensity. As such, one or both the sensors 52′, 52″ may be unnecessary. As discussed above with respect to the other flow filling challenges, instead of sensors 52′, 52″, it may be sufficient for the processor of the controller to extrapolate the position of the flow front F based on a flow rate determined from data provided by the first sensor 52, and then adjust or deactivate the induction heater based on a predicted time based on that flow rate, consistent with the flow front F reaching a location downstream of the flow filling challenge.

### Obstacles

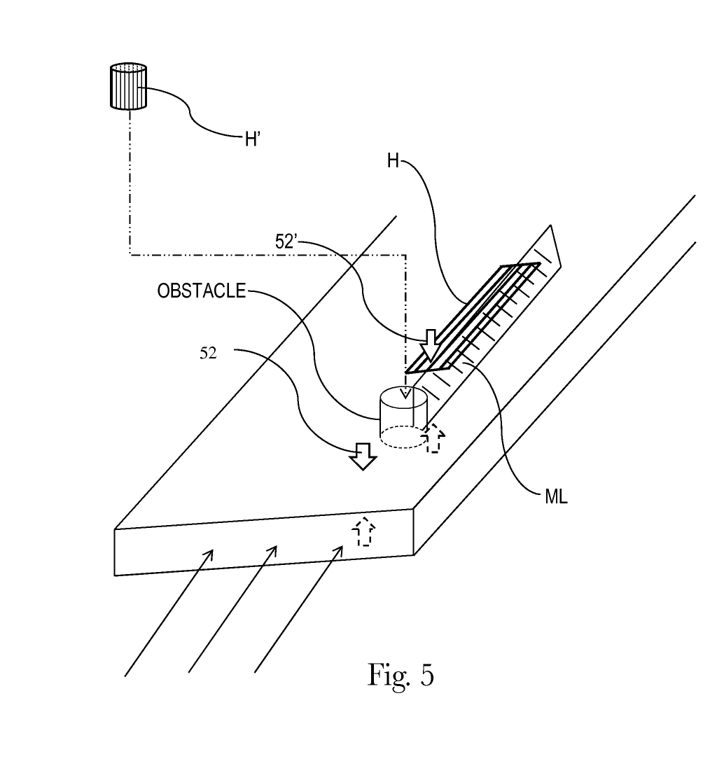

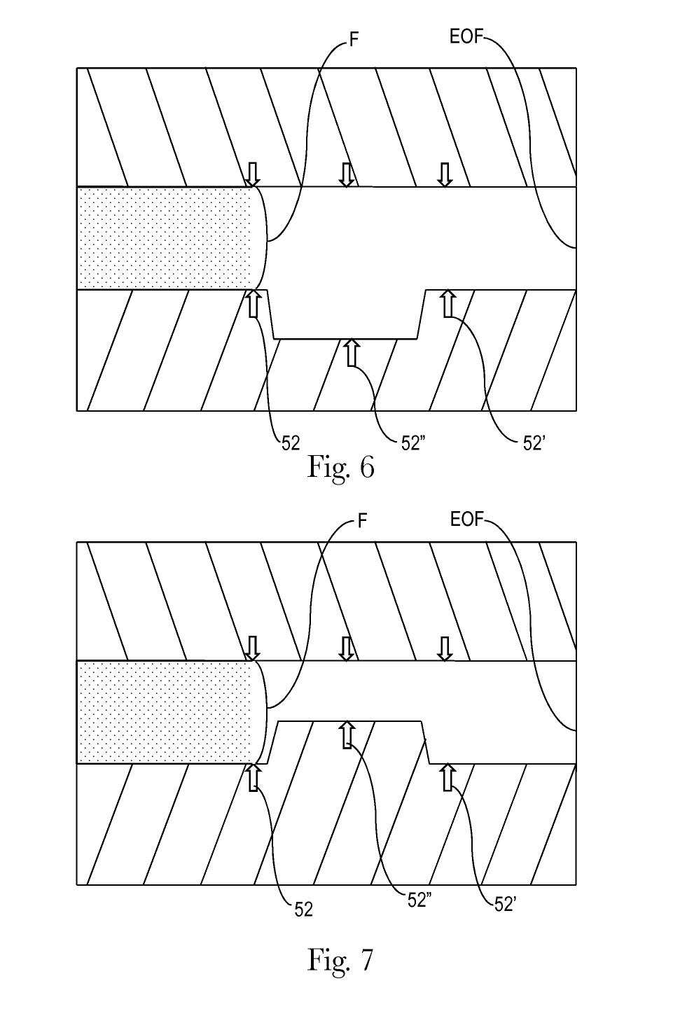

FIG. 5 illustrates an obstacle in the form of a core pin around which a melt flow must navigate within a mold cavity. Such an obstacle is often associated with the generation of a detrimental meld line ML in molded parts, due to the division of the flow stream into multiple streams that then come together again downstream of the obstacle. By applying a rapid heating technique to a region of the flow filling challenge posed by the obstacle, detrimental effects of the meld line can be mitigated. For instance, an induction heater H can be provided in the mold surface downstream of the core pin obstacle. Instead or in addition, the core pin itself may be provided with an induction heater H′. Heating the core pin such as with an induction heater H′ advantageously promotes better intermolecular entanglements downstream of the core pin, thereby improving meld line strength.

As in the cases of the flow filling challenges discussed above, a first sensor 52 may be used to detect the presence of the flow front F at a first position upstream of the obstacle. The first sensor 52 may signal a controller to initiate the induction heater H and/or H′ upon detection of the flow front F reaching the first position. A second sensor 52′ may be provided at a second position downstream of the obstacle. If desired to discontinue or reduce the intensity of induction heater H and/or H′ upon the flow front F reaching the second position, a signal received by the controller from the second sensor 52′ may be an event that triggers the controller to so alter the induction heater H and/or H′. However, as the effects of the obstacle in promoting a meld line for at least some distance downstream of the obstacle, it may be desired to continue operating the induction heater H and/or H′ for at least some duration of time after the flow front F passes the obstacle, perhaps even to the end-of-fill or for some time thereafter. In the event induction heaters H and H′ are both present, it may be sufficient or desirable to provide induction heat to one of the induction heater locations H′ only until the flow front F passes the core pin, but continue to operate the other induction heater H for some duration of time after the flow front F passes sensor 52′, perhaps even until end-of-fill or for some duration thereafter.

### Transitions

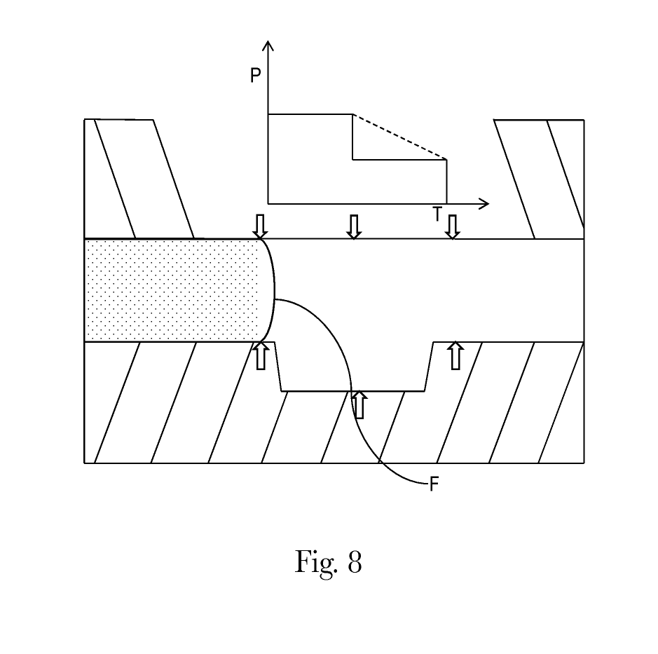

Turning now to FIGS. 6 and 7, flow filling challenges in the form of transitions in wall thickness are illustrated. Transitions in wall thickness can compromise the structural integrity of molded parts due to stress concentrations in the vicinity of each corner where the part changes from nominal wall thickness to a greater wall thickness (in the instance illustrated in FIG. 6) or to a thinner wall thickness (as illustrated in FIG. 7). Another defect often found in molded parts having thickness transitions is non-fill, where the molten thermoplastic material freezes off before completely filling the region of the mold that is thicker than the nominal wall thickness. Instead of driving the molten thermoplastic material at higher pressure and/or initial temperature, these problems can be alleviated by applying induction heat or other rapid heating technique to a vicinity of the transition in wall thickness.

A first sensor 52 positioned upstream of the flow filling challenge can detect the presence of the flow front F at that first position, and signal the controller to activate an induction heater. A second sensor 52′ positioned at a second position downstream of the transition can, upon detection of the flow front F at that second position, signal the controller to deactivate, or reduce the intensity of, the induction heater. Alternately, induction heating may continue until the flow front F reaches end-of-fill (EOF), or for some duration thereafter.

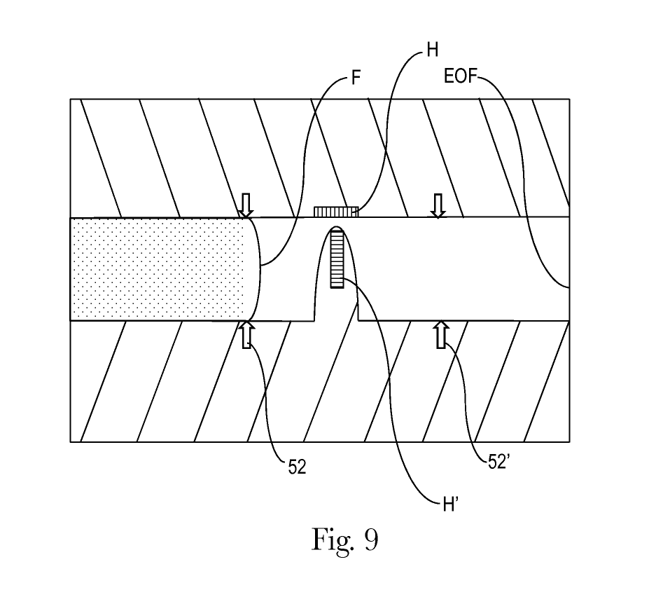

A third sensor 52″ may be provided along the relatively thick region (in FIG. 6) or relatively thin region (in FIG. 7) of the mold to detect the presence of the flow front F along that transition. Upon detection of the flow front F at the position of the third sensor 52″, the intensity of the induction heater may be adjusted. FIG. 8 illustrates a plot of induction power vs. time superimposed on the illustration of the transition flow filling challenge depicted in FIG. 6. As illustrated in the plot, from the time the induction heater is activated (which may, for instance, be at least as early as detection by the first sensor 52 detecting the presence of the flow front F at the first position upstream of the transition), the induction heater operates at a first induction power level. Upon the flow front F reaching the position of the sensor 52″ of FIG. 6, the induction power of the induction heater is reduced to a second induction power level lower than the first induction power level. The induction heater continues to operate at that reduced level until detection of the flow front F at a position downstream of the transition, such as the position of the sensor 52′ of FIG. 6.

### Living Hinge

Another example of a flow filling challenge that would benefit from the use of localized induction heating or other rapid heating technique, coupled with injection molding at substantially constant pressure, is a living hinge. A living hinge is a result of a particular transition where a mold cavity is shaped to mold a part having a region so thin relative to a nominal wall thickness that one portion of the molded part can be actuated relative to another integral portion of that same molded part along the thin region. An example of a living hinge is a flip-top cap of a shampoo bottle or of a refillable water bottle. The molded part at the living hinge may have a thickness of as little as 0.25 mm in a part having a nominal wall thickness of 1 mm.

The problems associated with transitions can be exacerbated in the case of living hinges because the wall thickness is so small. Conventional injection molding practices leave inadequate time for crystalline formation in semi-crystalline polymers at living hinges. There tend to be more molded in stresses in living hinge locations, and the flexural modulus (which impacts the opening force for a living hinge-type flip-top cap) is typically too low.

By providing induction heating to the vicinity of the living hinge, molded in stresses can be relieved or avoided, the thermoplastic material can be kept at its melt temperature for a longer period of time at the location of the living hinge (relative to overall mold temperature) to promote further crystalline formation, and as a result of the increased crystallinity, the opening force of the living hinge is increased.

As illustrated in FIG. 9, a first sensor 52 can be located at a first position upstream of the living hinge location. A second sensor 52′ may be located at a second position downstream of the living hinge location. The first sensor 52 may be used to signal a controller upon the flow front F reaching the first position to activate an induction heater H positioned in a wall of the mold above the living hinge, and/or to activate an induction heater H′ positioned within a portion of the mold that reduces the thickness of the mold cavity at the location of the living hinge. A second sensor 52″ may be located at a second position downstream of the flow filling challenge. Upon the flow front F reaching the second position, as detected by the second sensor 52′, the second sensor 52′ may signal the controller to deactivate or reduce the intensity of one or both of the induction heaters H, H′. Induction heating of one or both of the induction heaters H, H′ may continue, at full or reduced intensity, until the flow front F reaches the end-of-fill EOF, or for some duration beyond EOF.

### Weld Lines

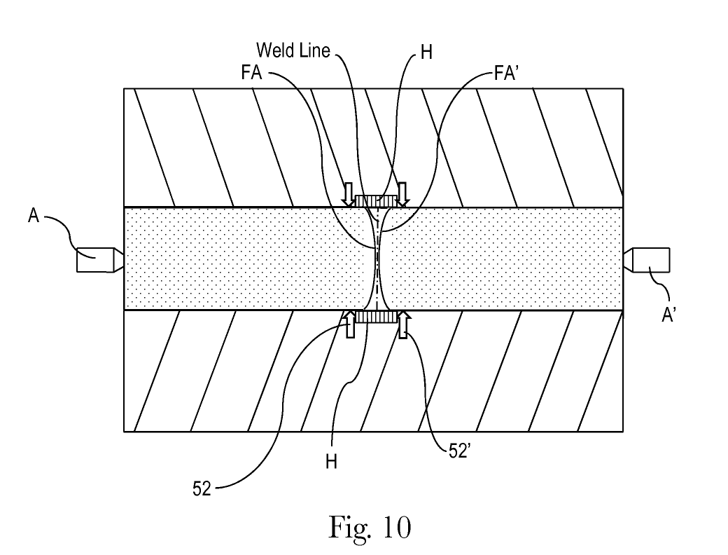

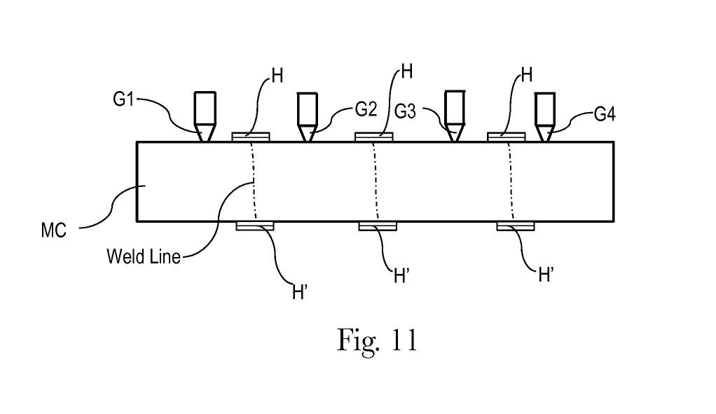

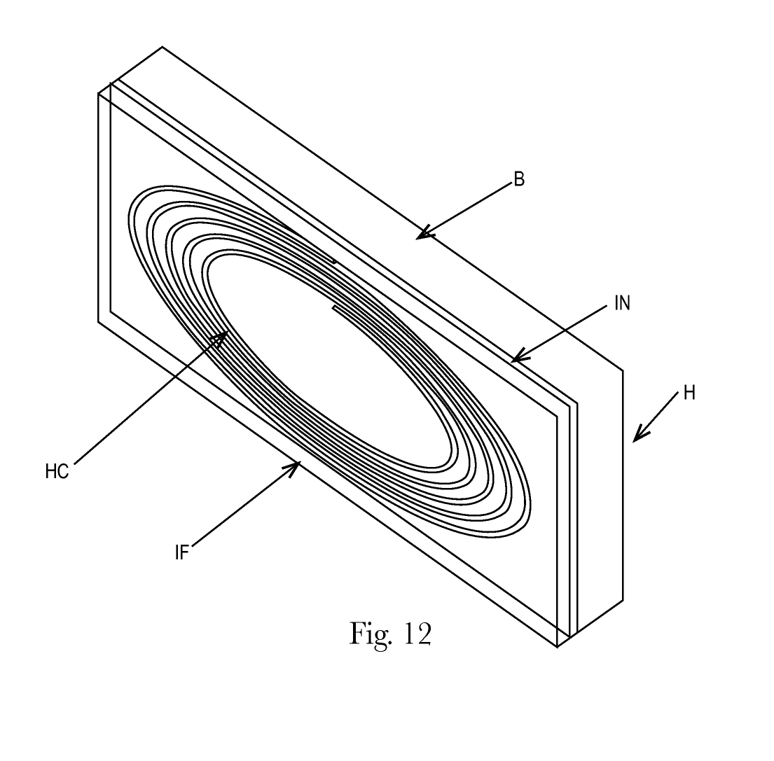

Another flow filling challenge, illustrated in FIGS. 10 and 11, is a weld line resulting from multiple gates or sources of molten thermoplastic material. For instance, with respect to FIG. 10, gates A and A′ introduce two distinct streams of molten thermoplastic material to a mold cavity. Where those streams come into contact with one another and flow along one another, with flow fronts FA and FA′, as the mold cavity fills, a weld line is created. With respect to FIG. 11, when multiple gates G1, G2, G3, and G4 are used to introduce molten thermoplastic material to a mold cavity MC, each gate generates a distinct flow front and weld lines are generated at each point of intersection of flow. Weld lines detrimentally create a location of diminished strength in a molded part. This can be alleviated by providing one or more induction heaters (or other surface heating technique) H, H′ in the vicinity of the mold where each weld line is generated. For instance, turning back to FIG. 10, a first sensor 52 and a second sensor 52′ can be used to detect the presence of the respective flow fronts FA and FA′ as they approach one another. The detection of the respective flow fronts FA and FA′ by the respective sensors 52, 52′ may in turn signal a controller to activate one or both induction heaters H along the location where a weld line will form as the two flow fronts FA and FA′ come together.

### Induction Heaters

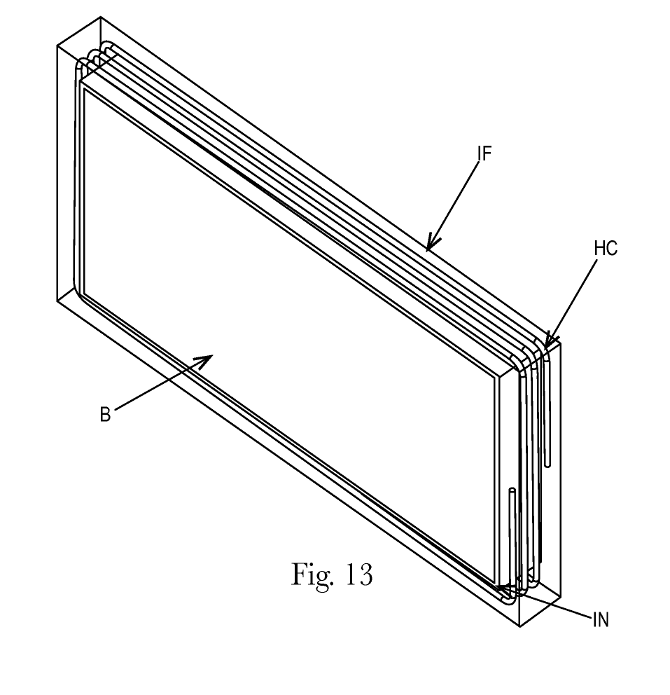

An example of a rapid heating technique discussed herein is induction heating. Induction heating may employ an induction heater such as that illustrated in FIG. 12 or FIG. 13. A planar coil induction heater arrangement H is illustrated in FIG. 12, with an optional insulating plate IN, a block of a mold B (representing a mold surface to be heated), an induction coil frame IF, and an induction coil IC. Turning to FIG. 13, a perimeter coil induction heating arrangement is illustrated, including a block of a mold B to be heated, an induction coil frame IF, an optional insulator IN, and an induction coil IC. The portion of the mold heated by induction heating or other rapid heating technique may be less than 60%, less than 50%, less than 40%, less than 30%, less than 20%, less than 10%, less than 5%, less than 3%, less than 2%, or less than 1% of the surface area of the mold. It should be appreciated that these illustrations of induction heaters are by way of example only, and can be implemented in a wide variety of shapes and arrangements to achieve localized induction heating in the flow filling challenge regions depicted in the present disclosure. The heating source, such as an induction heater, directs heat to a region extending from at least 0.5% to 100% of the depth of the thickness of the part being molded at the location of the heating source. The portion of the mold that is heated by one or more induction heaters may occupy less than 100% of the surface area of the mold, preferably less than 80%, more preferably, less than 70%, more preferably, less than 60%, even more preferably, less than 50%, and even more preferably, less than 25%.

### Resin with Fillers

A particular class of thermoplastic materials that benefits from the use of localized rapid heating techniques while injection molding at substantially constant pressure is resin with filler, such as glass filled resins. By using cartridge heaters, induction heating, or other rapid heating techniques while injection molding with glass filled resins, a high gloss finish can be achieved in the finished part. The heat applied by the molding surface helps to bury the glass fibers deeper into the part than the skin layer. In addition to a high gloss finish, better aesthetics can be realized at weld lines, meld lines, and other flow filling challenge areas. Moreover, part strength in the vicinity of weld lines and meld lines is improved. Also, localized heating of the mold surfaces alleviates the need to depend entirely upon the initial temperature of the shot of glass filled resin, so molding can be performed at lower pressures and lower temperatures, notwithstanding the tendency for resin manufacturers to recommend higher molding temperatures for glass filled resins. As a result of these benefits, injection molders will be able to use resins having higher filler content without compromising aesthetics, strength, or other indicators of part quality. Because fillers tend to reduce resin costs, this ability will lower supply costs.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method, comprising:
injecting a molten thermoplastic material into a mold cavity defined by a mold of an injection molding apparatus;
obtaining, using a sensor, during the injecting, data associated with the molten thermoplastic material flowing at a pre-determined location of the mold cavity; and
controlling, via a controller communicatively connected to the sensor, a heating source arranged to locally heat at least a portion of the mold, the controlling being based on the obtained data.

2. The method of claim 1, wherein the obtaining comprises detecting the molten thermoplastic material flowing at the pre-determined location.

3. The method of claim 1, wherein the obtaining comprises detecting no molten thermoplastic material flowing at the pre-determined location.

4. The method of claim 1, wherein the obtaining comprises detecting at least one of a temperature, a melt pressure, or a flow rate of the molten thermoplastic material flowing at the pre-determined location.

5. The method of claim 1, wherein the pre-determined location corresponds to a location that is upstream of or at a flow filling challenge.

6. The method of claim 5, wherein the pre-determined location is upstream or downstream of the location of the flow filling challenge.

7. The method of claim 5, wherein the location of the flow filling challenge comprises at least one of a rib, a boss, a corner, an obstacle, a transition, or a living hinge.

8. The method of claim 5, wherein the flow filling challenge corresponds to a pre-determined amount of the molten thermoplastic material experiencing freeze-off at the pre-determined location.

9. The method of claim 1, wherein the heating source is arranged to locally heat a region of the mold, which in turn heats a skin layer of the molten thermoplastic material.

10. The method of claim 9, wherein the heating source directs heat to a region extending from at least 0.5% to 100% of the depth of the thickness of the part at the location of the heating source.

11. The method of claim 1, wherein the portion of the mold is one of upstream of, at, proximate to, or downstream of the pre-determined location.

12. The method of claim 11, wherein the portion of the mold is at the pre-determined location.

13. The method of claim 1, wherein the portion of the mold comprises less than 60% of a surface area of the mold.

14. The method of claim 1, wherein the controlling comprises activating the heating source based on the obtained data.

15. The method of claim 1, wherein the controlling comprises at least one of shutting off the heating source based on the obtained data, reducing the intensity of the heating source based on the obtained data, or increasing the intensity of the heating source based on the obtained data.

16. The method of claim 1, wherein the controlling comprises increasing or decreasing at least one of an intensity of the heat output by the heating source and a temperature of the heat output by the heating source based on the obtained data.

17. The method of claim 1, wherein the controlling comprises cycling the heating source on and off based on the obtained data.

18. The method of claim 1, wherein the obtaining comprises detecting the molten thermoplastic material flowing proximate to the pre-determined location, and wherein the controlling comprises activating the heating source to locally heat the portion of the mold.

19. The method of claim 1, wherein the obtaining comprises detecting no molten thermoplastic material flowing proximate to or at the pre-determined location, and wherein the controlling comprises at least one of
shutting off the heating source so as to one of disrupt, prevent, or discontinue localized heating of the portion of the mold;
increasing the intensity of the heating source; or
decreasing the intensity of the heating source.

20. The method of claim 1, wherein the obtaining comprises detecting no molten thermoplastic material flowing at the pre-determined location.
